(19) United States
(12) Patent Application Publication
(10) Pub. No.: US 2005/0233468 A1
(43) Pub. Date: Oct. 20, 2005

(54) Method of local rheological measurement by fluorescent microscopy and a new fluorescent probe for polyacrylamide polymer molecules

(75) Inventors: Abraham Warshawsky, Rehovot (IL); Victor Steinberg, Rehovot (IL); Corinne Chevallard, Gemenos (FR); Ying Wang, Detroit, MI (US)

Correspondence Address: BROWDY AND NEIMARK, P.L.L.C.;624 NINTH STREET, NW, SUITE 300, WASHINGTON, DC, 20001-5303, US

(73) Assignee: Yeda Reasearch and Devlopment Co., Ltd., Rehovot (IL)

(21) Appl. No.: 10/502,591

(22) PCT Filed: Jan. 23, 2003
(86) PCT No.: PCT/IL03/00061

§ 371 Date: Mar. 3, 2005

(30) Foreign Application Priority Data
Jan. 24, 2002 (IL) 147839

(51) Int. Cl. G01N 21/64

(52) U.S. Cl. 436/172; 436/145; 436/166

(57) ABSTRACT

The present invention is directed to a complex comprising of a polymer and a fluorescent probe, a method for its preparation and use thereof for measuring dynamics of single molecules in a polymeric solution.

### FIELD OF THE INVENTION

The present invention relates to formation of chemical complex and use thereof for measuring dynamic flow properties and microenvironmental changes.

### LIST OF REFERENCES

The following is a list of references, which is intended for a better understanding of the background of the present invention.
Bodarenko, N. V., Skripnik, V. A., Revenko, Y. V. Bannikov, V. V., Fishman, G. I., Vishnevskaya, L. N. (1993) U.S.S.R. SU 1,798,323.
Biye, R, Feng, g., Zhen, T., Yu, Y. I(1999) Chem. Phys. Letter 307, 55-61.
Candau, F., Regalado, E. J., Selb, J. (1998) Macromolecules 31, 5550-5552.
Dragusin, M. Martin, D. Radoiu, M. Moraru, R. Oproiu, C., Marghitu, S. Damitrica, T. (1996) Prog. Colloid Polym. Sci. 102(Gels), 123-125.
Grant, K. W. and Barbara, I. (1997) J. Am. Chem. Soc. 119, 3443-3450.
Hu, Y., Horie, K., Torii, T., Ushilci, H. (1992) Macromolecules 25, 6040-6044.
Hu, Y., Horie, K., Torii, T., Ushiki, H., Tsunomori, F., Yamashita, T. (1992a) Macromolecules 25, 7324-7329.
Hu, Y., Horie, K., Torii, T., Ushiki, H., Tang, X. (1993) Polymer J. (Tokyo) 25, 123-130.
Huff, J. B., Bieniarz, C., Horng, W. J., USA (1997), U.S. Pat. No. 5,661,040.
Kobayashi, K. Bull. (1975) Chem. Soc. Jpn. 48, 1750-1754.
Maeda, M. (2000) Chromatography 21, 292-293.
Mikami, M., Ueta, T., Kobayashi, D., Koreeda, A., Saikan, S. J. (2000) J. Lumin 86, 257-267.
Mylonas, Y., Karayami, K., Staikos, G., Koussathana, M., Lianos, P. (1998) Langmuir 14, 6320-6322.
Rivas, B. L. and Moreno-Villoslada, I. J. (1998) J. Appl. Polym. Sci. 69, 817-824.
Rosen, O., Piculell, L., Hourdet, D. (1998) Langmuir 14, 777-782.
Sen, M., Uzun, C., Guven, O. (2000) Int. J. Pharm. 203, 149-157.
Starodoubtsev, S. G. and Yashikawa, K. (1998) Langmuir 14, 214-217.
Starodoubtsev, S. G., Churochkina, N. A., Khokhlov, A. R. (2000), Langmuir 16, 1529-1534.
Tanba, Chiaki, Okamura, K. (1999) Jpn. Kokai Tokkyo Koho JP11128954.
Wang, Y., Han, B., Yan, H., Kwak, J. C. T. (1997) Langmuir 13, 3119-3123.
Winnik, M. A. and Borg, R. M (1989) U.S. Pat. No. 4,813,973.
Zettlitzer, M. (1995) Ger. Offen. DE 4,330,688.
Zhou, Y., Hao, L.-Y., Yu, S.-H., You, M. Zhu, Y.-R., Chen, Z.-Y. (1999) Chem. Mater. 11, 3411-3413.

### BACKGROUND OF THE INVENTION

Polymers in general are prone to conformational changes and phase transitions when their microenvironment is changed. Addition of surfactants (Starodoubtsev, S. G. et al. 2000; Mylonas, Y. et al. 1998), altering the pH (Sen, M. et al. 200), addition of salts (Starodoubtsev, S. G. et al. 2000), all change the conformation of polymers. Molecular behavior in response to external stimuli is studied by various physical methods, such as light scattering (Ying, Q. et al. 1996), fluorescence (Mylonas Y. et al. 1998; Mikami, M. et al. 2000), viscosity (Mylonas Y. et al. 1998; Candau, F., et al. 1998), microcalorimetry (Wang, Y., et al. 1997) and other methods. One other approach, is to label the polymer and monitor the labeled polymer. Biological polymers, peptides and amino acids are frequently labeled by attaching a dye and monitoring the dye (Grant, K. W. and Barbara, I. 1997). Labeling of synthetic polymers with dyes for studying dynamics are also known. Amidoalkylation of carbocation dyes to high molecular weight polyacrylamide (Winnik, M. and Borg, R. 1989), pyrene (Hu, Y. et al. 1993; Mylonas, Y. et al. 1998) and dansyl (Hu, Y. et al. 1992; Hu, Y. et al. 1992a) were further used to study interactions of polyacrylamide in gels, i.e. probing conformational changes.

In recent years there is a growing interest in polyacrylamides and some of their chemical derivatives. Part of the growing interest may be attributed to a general interest in hydrosoluble polymers which are important in biological studies (Maeda, M. 2000; Starodoubtsev, S. G. and Yashikawa, K. 1998), agriculture (Dragusin, M., et al. 1996), material (Zhou, Y., et al. 1999) and environmental (Rivas, B. L. and Moreno-Villoslada, I. J. 1998) applications. Thus partially hydrolyzed polyacrylamide (HPAm), that is soluble in aqueous or mixed aqueous solutions has promising applications in oil recovery (Zettlitzer, M. 1995), removing metal ions (Kobayashi, K. 1975), or phosphates (Bondarenko, N. et al. 1993) from dilute solutions and waste water. It may further be used as a polyelectrolyte in solutions as a coagulant in the treatment of solid-containing water (Tanba, C. and Okamura, K. 1999) and wastewater containing zinc and chromium (Hiratsuka, M. and Andoo, N. 1999). There is thus a need in the art to provide efficient tools to study conformational and viscosity changes, chain elongations of polymers in their various applications since such parameters reflect the changes in the microenvironment of the polymer.

### SUMMARY OF THE INVENTION

The present invention is based on the fact that a fluorescent probe may be chemically linked to a polymer thus creating a fluorescent-labeled polymer. Dynamical behavior and conformational analysis of the labeled polymer arc reflected in the fluorescent probe. Thus monitoring the fluorescent probe gives informative data regarding the dynamics of the polymer in solution.

The invention is thus directed in one embodiment to a complex formed by the reaction of a compound of formula (I): 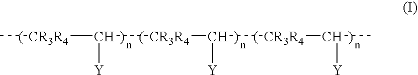
with a fluorescent compound of formula (II): 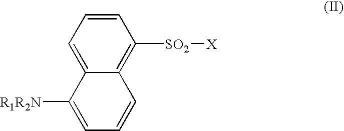
wherein R₁—R₄ may be the same or different and are selected from hydrogen, substituted or non-substituted C₁-C₁₂-alkyl, C₁-C₁₂-alkenyl, phenyl, alkylphenyl; n is from 0 to 120; X and Y are functional groups that may interact one with the other to form the desired chemical bond and are chosen independently from halogen, amino, carboxyl, carboxamide, C₁-C₁₂-halogen, C₁-C₁₂alkyl-NH₂, NH₂—C₁-C₁₂alkyl-NH₂, C₁-C₁₂-carboxyl, C₁-C₈-hydroxy, where Y groups may be the same or different.

Preferably, the chemical complex formed is of formula (III):

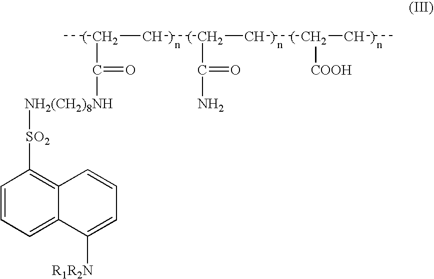

The invention is further directed to a method for measuring dynamics of single-molecule in solution comprising the steps of
(a) forming a chemical complex by reacting a compound of formula (I) with a compound of formula (II);
(b) measuring the fluorescence of said chemical complex or visualizing said chemical complex directly.

The invention is yet further directed to use of a complex formed by the reaction of a compound of formula (I) with a compound of formula (II), for the measurement of dynamic flow properties of the chemical complex. Preferably the chemical complex of formula (III) is used for studying the dynamics of polyacrylamide polymers.

The invention relates also to a process for preparing the labeled complex of formula (III) by derivatizing a known fluorescent probe to a bi-functional moiety prior to the attachment of the fluorescent probe to the polymer.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows chemical structures of several agents and schemes of reactions of the present invention.

FIGS. 2A and 2B show absorption spectrum at constant pH (pH=5.6); of HPAm at various concentrations (2A), and of a mixture containing HPAm at various concentrations and DNSNH(CH₂)₈NH₂.

FIG. 3 shows fluorescence emission response of DNSNH(CH₂)₈NH₂ in increasing concentrations of HPAm.

FIGS. 4A and 4B show the ultraviolet (4A) and fluorescence spectra (4B) of free DNSNH(CH₂)₈NH₂ and of HPAm labeled with DNSNH(CH₂)₈NH₂.

FIGS. 5A 5B show pH dependence of the emission (5A) and fluorescent peak wavelength (5B) for free DNSNH(CH₂)₈NH₂ and when bound to BPAM.

FIGS. 6A and 6B show influence of 5% NaCl on the fluorescence of free DNSNH(CH₂)₈NH₂ (6A) and DNSNH(CH₂)₈NH₂ bound to HPAm (6B).

FIG. 7 shows the influence of the presence of metal ions on the fluorescence emission.

FIG. 8 shows schematically the apparatus used for measuring viscosity (A) and viscosity measurements of non-labeled and labeled HPAm (B).

FIGS. 9A-D show the effect of addition of NaCl on free and labeled polymer (DNSNH(CH2)₈NH₂ labeled HPAm) on the viscosity (9A) and its dependency on various experimental parameters No. of labels per chain (9B), pH (9C), extent of degradation (9D).

FIG. 10 shows an experimental set-up for visualization of polymer molecules under flow with a fluorescent microscope.

FIG. 11 shows fluorescent microscopy photographs of extended labeled polymer.

### DETAILED DESCRIPTION OF THE INVENTION

The present invention deals with the synthesis of fluorescent-labeled chemical complex. In particular it relates to the labeling of a polymeric structure. It further deals with visualizing the fluorescent-labeled polymeric complex and measuring its fluorescence for studying the polymer dynamics and flow properties in solution under different environments. The formed polymer may be used for visualization of single-molecule dynamics.

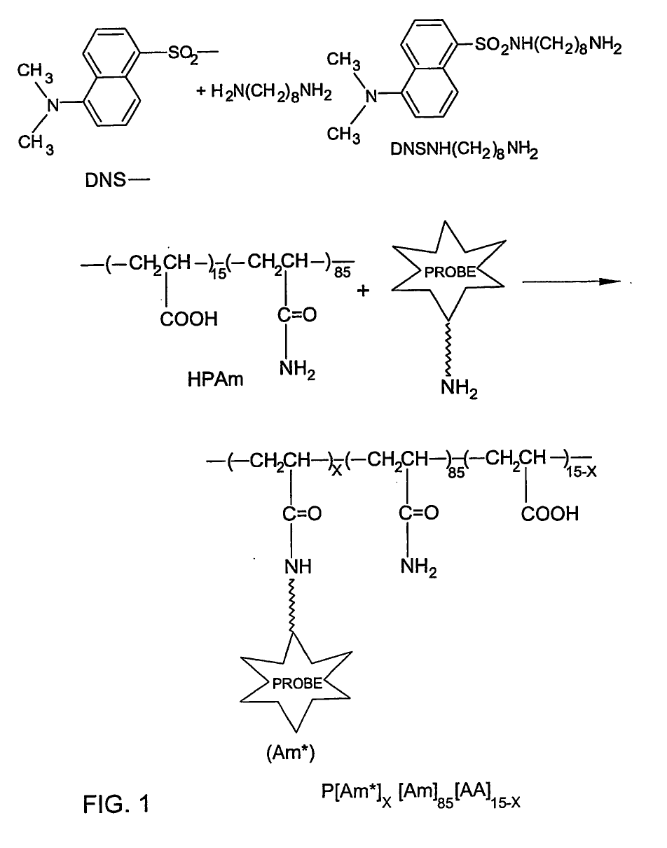

A prerequisite of such a labeling process is that the label attached to the polymer does not significantly alter the physical properties of the polymer, such as the molecular weight, viscosity (flexibility) and geometry (conformation). In addition the degree of labeling, i.e. the number of labeled groups per repeating unit should also be controllable in order to monitor the fluorescence intensity. Polyacrylamides and derivatives thereof are an important family of polymers. Polyacrylamides undergo remarkable conformational modifications and phase transitions in response to external factors. Presence of surfactants, change of the pH, and addition of salts, all effect the polymer's conformation. Hydrosoluble polyacrylamide, due to their ability to dissolve in aqueous and mixed aqueous solutions are used in various applications and the present invention deals therefore with the fluorescent labeling of the hydrosoluble derivative of polyacrylamide. The labeled polymer of the present invention was synthesized directly from partially hydrolyzed polyacrylamide (HPAM) in order to avoid partial hydrolysis usually required in the process of labeling polyacrylamides. The core of the fluorescent probe is a known fluorophore, dansyl chloride (5-dimethylamino-1-naphthalenesulphonamide) whose structure is shown in FIG. 1. However, in order to facilitate bonding of the fluorescent probe to the polymer, the dansyl moiety was first converted into a bifunctional moiety. Thus the dansyl chloride was reacted to yield N-(8-aminooctanyl)-5-dimethylamino-1-naphthalene-sulphonamide (hereafter DNSNH(CH2)₈NH₂). It should be understood that although the dansyl chloride is a known fluorescent probe frequently used in the is field of DNA and peptide labeling, the synthesized DNSNH(CH2)₈NH₂) moiety for the purpose of labeling in the present invention and the resulting polymer-DNSNH(CH2)₈NH₂ moiety are unique. The DNSNH(CH2)₈NH₂ is then reacted (condensed) with the COOH group of the HPAm to form the fluorescent polymer, hereinafter termed as P[Am*]ₓ[Am]₈₅[AA]₁₅₋ₓ (AA-acrylic acid; Am-acrylamide; AM*-labeled acrylamide) as shown in FIG. 1. As shown, it is possible and advisable to label only a limited number of the polymer's carboxylic groups. Labeling of all free carboxilic acids leads to a distorted polymer that is useless for measuring dynamics and behavior (vide infra). The possibilities, these two new compounds, the fluorescent probe and the labeled polymer, open in the field of studying directly dynamics of polymers in general and specifically those of polyacrylamides are the main cores of the invention.

The attached fluorescence probe is sensitive to conformational changes of the polymer. Thus changes in the fluorescence spectrum of the probe reveals changes in the polymer which occur in response to external changes in the microenvironment of the polymer. The change of the microenvironment may be as a result of a change in the pH, in the salt concentration, presence of different ions in the vicinity of the polymer or some other change in the microenvironment of the polymer. The dynamical behavior and the kinetics of such conformational changes of the labeled polymer may thus be elucidated. As mentioned the binding of the fluorescent probe enables single-polymer visualization, by fluorescence microscope, a unique application in the field of synthetic polymers.

The feasibility of direct labeling of a moiety having free carboxylic groups with the new bi-functional fluorescent probe of the invention, DNSNH(CH2)₈NH₂ moiety, was proved by reacting the fluorescent probe with caproic acid. The reaction of DNSNH(CH2)₈NH₂, with caproic acid yields the desired product (confirmed by NMR—see example 2). Turning to labeling the polymer, HPAm, the appropriate solvent system was sought such that the water soluble, conformationally sensitive HPAm moiety would indeed undergo the desired coupling reaction. DNSNH(CH2)₈NH₂) is incompatible with aqueous solutions with pH>3, therefore a water-miscible co-solvent must be added to dissolve the DNSNH(CH2)₈NH₂), without causing precipitation of the HPAm. A solvent system comprising DMSO:H₂O in the ratio of 1:1 was found to be an excellent system for carrying the coupling reaction, since in such a solvent system the DNSNH(CH2)₈NH₂) may be solubilized without effecting the HPAm. The reaction was done such that different concentrations of DNSNH(CH2)₈NH₂) were reacted with a fixed concentration of HPAm in order to yield various polymers, each labeled to a different extent. In the labeled product, P[Am*]ₓ[AM]₈₅[AA ]₁₅₋ₓ, multiple covalently bound dansyl group cause interpolymeric entanglements. The experimental conditions and results are shown in Table 1 (Example 3) where it was found that at a ratio above 1:0.66 a turbid solution is obtained indicative of such interpolymer entanglements. Therefore for fluorescent measurements, a much lower ratio of COOH to dansyl group, ca. 1:0.2 was used.

Table 2 summarizes several physical properties of DNSNH(CH2)₈NH₂ at a concentration of 1×10⁻⁵ mol/l in several organic solvents. The lowest absorption band is red-shifted for all solvents compared to DNSNH(CH2)₈NH₂) in water, where among the 12 different solvents examined it is rather constant. The maximum emission, however, varies with the different solvents used. As apparent, the dansyl probe shows an increased emission intensity and maximum emission blue-shift when going from water to less polar media As such variations in the spectrum are employed in conformational transitions studies of proteins and synthetic polymers, one may anticipate that the DNSNH(CH2)₈NH₂ may serve as an effective and sensitive probe to measure inter and intra-polymer interactions. The relative fluorescence intensity and relative attenuations measured would be indicative of the extent of such inter and intra polymer interactions.

TABLE 2

| Solvent | λabs (nm) | λmax (nm) | RFI |
|---|---|---|---|
| Water | 329 | 549 | 7171 |
| Dimethyl sulfoxide | 339 | 555 | 41498 |
| Methanol | 339 | 503 | 44444 |
| Dimethylformamide | 340 | 503 | 61424 |
| Ethanol | 338 | 500 | 43448 |
| Acetone | 345 | 500 | 10411 |
| Dichloromethane | 346 | 500 | 25651 |
| Tetrahydrofuran | 339 | 493 | 93597 |
| Dioxane | 333 | 483 | 116884 |
| Benzene | 341 | 481 | 68916 |
| Diethylether | 338 | 471 | 121398 |
| n-Hexane | — | 455 | 7127 |

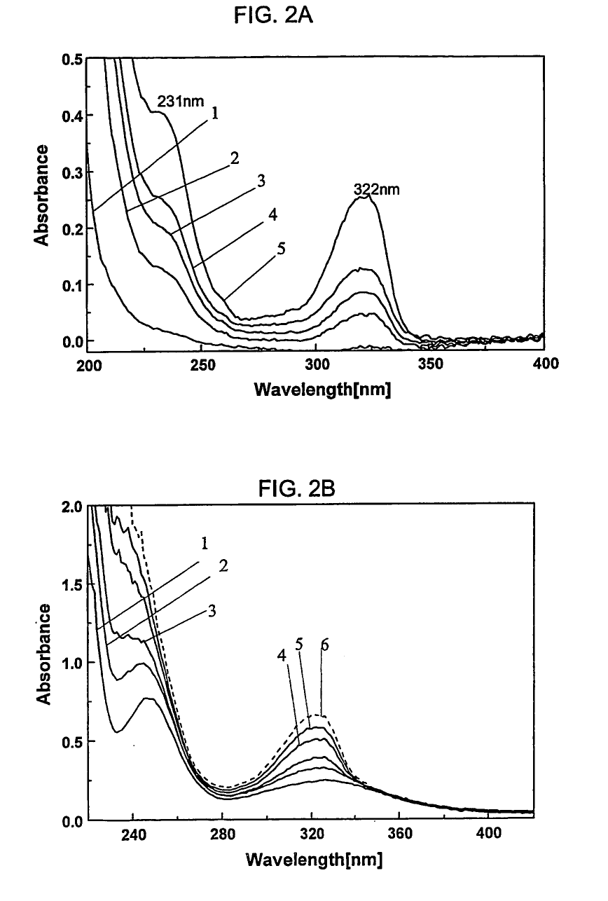

Turning now to FIG. 2A, there are illustrated absorption spectrum of BPAm alone in various concentrations, where the absorption spectrum at concentrations of 20, 100, 150, 200 and 250 ppm HPAm, are shown by lines 1-5, respectively. FIG. 2B illustrates absorption spectrum of a mixture of various concentrations of HPAm with 5×10⁻⁵ mol/l DNSNH(CH2)₈NH₂ at pH=5.6 (buffer). Absorption spectrum at HPAm concentrations of 100, 200, 300, 400, 500 and 600 ppm, are shown by lines 1-6, respectively. DNSNH(CH2)₈NH₂ shows two bands at 246 and 326 nm. The lowest energy absorption band of HPAm at 322 nm overlaps with that of the 326 nm band of DNSNH(CH2)gNH₂ making it impossible to see interactions between HPAm and free dansyl probe (DNSNH(CH2)₈NH₂).

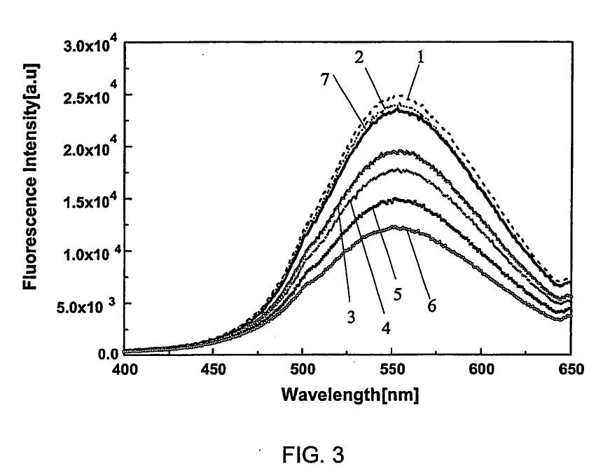

Turning to FIG. 3, the emission spectrum of a solution comprising of 5×10⁻⁵ mol/l DNSNH(CH2)₈NH₂ at increasing concentrations of HPAm is shown. Emission spectrum of solutions comprising of concentrations of 100, 200, 300, 400, 500 and 600 HPAm ppm are shown by lines 1-6, respectively. Line 7 shows the emission of 5×10⁻⁵ mol/l DNSNH(CH2)₈NH₂. The position of the maximum fluorescence wavelength remains constant, indicative of the fact that the microenvironment of the DNSNH(CH2)₈NH₂ is not altered. However, at concentrations higher than 300 ppm of polymer, the fluorescence is quenched, probably due to hydrogen bonding between the DNSNH(CH2)₈NH₂ and HPAM.

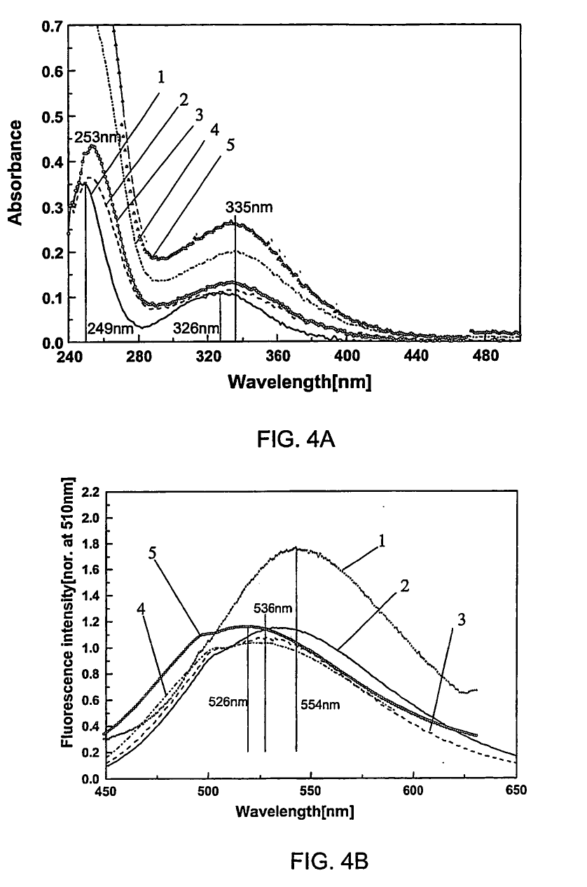

FIGS. 4A and 4B describe the absorption (U.V.) and fluorescence spectrum of DNSNH(CH2)₈NH₂ in free and when bound to HPAm. The two characteristic U.V. absorption bands of free DNSNH(CH2)₈NH₂ at 249 and 326 are present also in the bound state, however, these are red-shifted (FIG. 4a). Line 1 shows the absorption of 5×10⁻⁵M dansyl probe in a solution containing 257 ppm NaN₃ (preservative). Line 2 shows the absorption of a 61.4 ppm sample comprising of 777 dansyl probe in a solution containing 257 ppm NaN₃. Line 3 shows the absorption of a 45.1 ppm sample comprising of 17394 dansyl probe in a solution containing 257 ppm NaN₃. Line 4 shows the absorption of a 88.5 ppm sample comprising of 18881 dansyl probe in a solution containing 257 ppm NaN₃. Line 5 shows the absorption of a 66.458 ppm sample comprising of 19182 dansyl probe in a solution containing 257 ppm NaN₃. Turning to FIG. 4b, in the fluorescence spectrum, free 5×10⁻⁵ mol/l DNSNH(CH2)₈NH₂ shows a maximum emission at 554 nm (line 1), while when bound to the polymer, P[Am*]ₓ[Am]₈₅[AA]₁₅₋ₓ the emission is blue-shifted. Line 2 shows the spectrum of a 61.4 ppm sample comprising of 777 dansyl probe in a solution containing 257 ppm NaN₃. Line 3 shows the spectrum of a 45.1 ppm sample comprising of 17394 dansyl probe in a solution containing 257 ppm NaN₃. Line 4 shows the spectrum of a 88.5 ppm sample comprising of 18881 dansyl probe in a solution containing 257 ppm NaN₃. Line 5 shows the spectrum of a 66.458 ppm sample comprising of 19182 dansyl probe in a solution containing 257 ppm NaN3. The blue-shift is proportional to the extent of labeling (“dansylation”) of the polymer, P[Am*]ₓ[Am]₈₅[AA]₁₅₋ₓ. Up to a number of several hundreds of DNSNH(CH2)₈NH₂ probes attached to the polymer chain, the fluorescence peak is shifted from 554 nm to 532 nm. A further increase in the number of DNSNH(CH2)₈NH₂ groups bound to the polymer shifts the emission peak to 526 nm. Such an emission originates from a known phenomenon termed “Twisted Intramolecular Charge Transfer” (TICT) state, in which the plane of the dimethylamino group is almost perpendicular to the naphthalene ring plane (Biye, R. et al. 1999), and therefore is sensitive to the polarity of the medium. Thus this shift may directly express changes in the fluorescent probe microenvironment. An increase in the number of dansyl groups along the polymer chain enhances hydrophobic interactions between the dansyl groups and the polymer deriving the dimethylamino group to a further twist with respect to the naphthalene ring, causing a shift to even shorter wavelengths. Measuring the fluorescence of the labeled polymer P[Am*]ₓ[Am]₈₅[AA]₁₅₋ₓ during the reaction is thus a useful tool for determining the progress of the reaction since dansylation of HPAm changes its conformation and possibly its polymeric properties. Such a phenomenon is known from dansylated butyl copolymer that undergoes a conformational transition from a hypercoiled state to a random coil state.

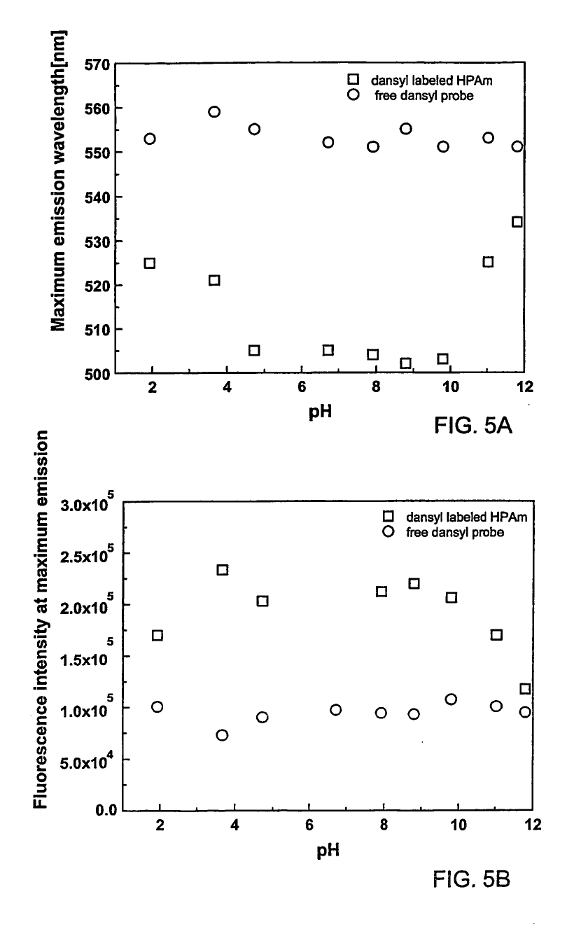

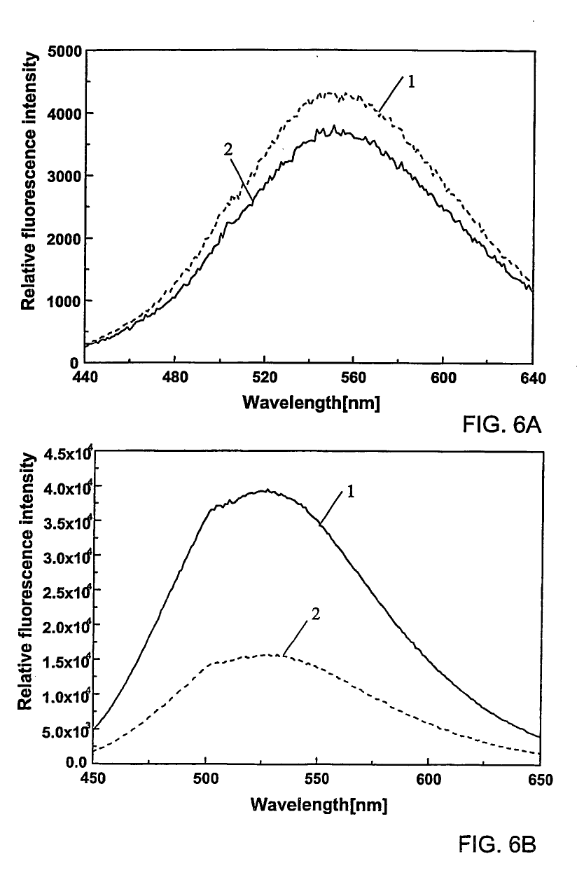

The change in the fluorescent spectrum of the bound fluorophore as a result of alteration of the microenvironment of the labeled polymer was studied. Such studies show the utility of using the fluorophore as a sensitive measure of minute changes in the microenvironment of the bound polymer. The effect of changes in pH values on free DNSNH(CH2)₈NH₂ and HPAm labeled by DNSNH(CH2)₈NH₂ are shown in FIG. 5. The emission wavelength λₘₐₓ and the corresponding fluorescence intensity of free DNSNH(CH2)₈NH₂ (5×10⁻⁵ mol/l) are almost constant when the pH is varied. In contrast, the λₘₐₓ of 33.229 ppm DNSNH(CH2)₈NH₂ bound to HPAm (19182 dansyl probes per chain) depends on pH. A decrease in pH from 3.69 to 1.96 shifts λₘₐₓ to higher wavelengths (FIG. 5A), indicating an increase in the polarity of the local medium resulting from the protonation of the dimethylamine group of the DNSNH(CH2)₈NH₂ moiety. In the pH range of 3.69 to 9.8 the λₘₐₓ of the DNSNH(CH2)₈NH₂ labeled HPAm shifts to shorter (and constant) wavelength (FIG. 5A) and a slight increase in the fluorescence intensity may be observed (FIG. 5b). It is well known that dansyl groups in a hydrophobic environment exhibit maximum emission at shorter wavelengths and that an increase of the fluorescence intensity compared to that when in a hydrophilic environment is observed. Thus the observed changes in the intensity and in λₘₐₓ indicate that the fluorescent probe is in a hydrophobic microenvironment. Above a pH value of 9.8 λₘₐₓ shifts to higher wavelengths and fluorescence intensity gradually decreases, a phenomenon that can be attributed to the increase of polymer charge (COO⁻), that results in an expansion of the polymeric chain due to the electrostatic repulsion. Another change in the microenvironment of the polymer may be observed when the salt concentration of the solution is altered. Such an effect is shown in FIG. 6A, where line 1 represents fluorescence of 1×10⁻⁵ M dansyl probe in 257 ppm NaN₃ and line 2 represents fluorescence of 1×10⁻⁵ M dansyl probe in 257 ppm NaN₃ where 5% NaCl were added. It is well known that addition of salt, such as NaCl, to dilute solutions of HPAm changes significantly their flow behavior. Adding 5% NaCl to a solution of free DNSNH(CH2)₈NH₂ (1×10⁻⁵ mol/l) indeed quenched the fluorescence. However, in the bound complex the picture reverses. However, in the bound complex the picture reverses. Turning to FIG. 6B, line 2 shows the fluorescence of DNSNH(CH2)₈NH₂ when bound to HPAM (45.1 ppm; 17394 dansyl probes per chain) and line 1 shows the fluorescence of the same system after 5% NaCl were added. Thus in the complex, upon the addition of the salt the fluorescence is increased. A plausible explanation for the phenomenon is that the ionic strength influences the polymer conformation. Polyacrlamides may dissociate in solution to form polyvalent macroions, which produce strong electric fields that attract counterions. Thus it may be assumed that the labeled polymer possesses the same properties, and therefore the interaction of macroions with counterions leads to a significant effect on the properties of polyelectrolytes.

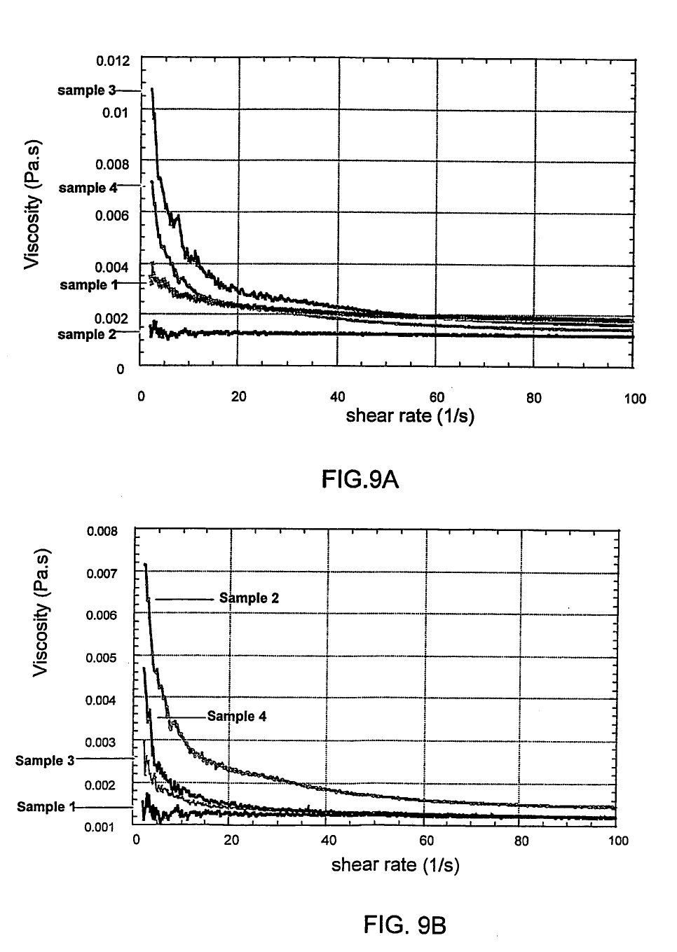

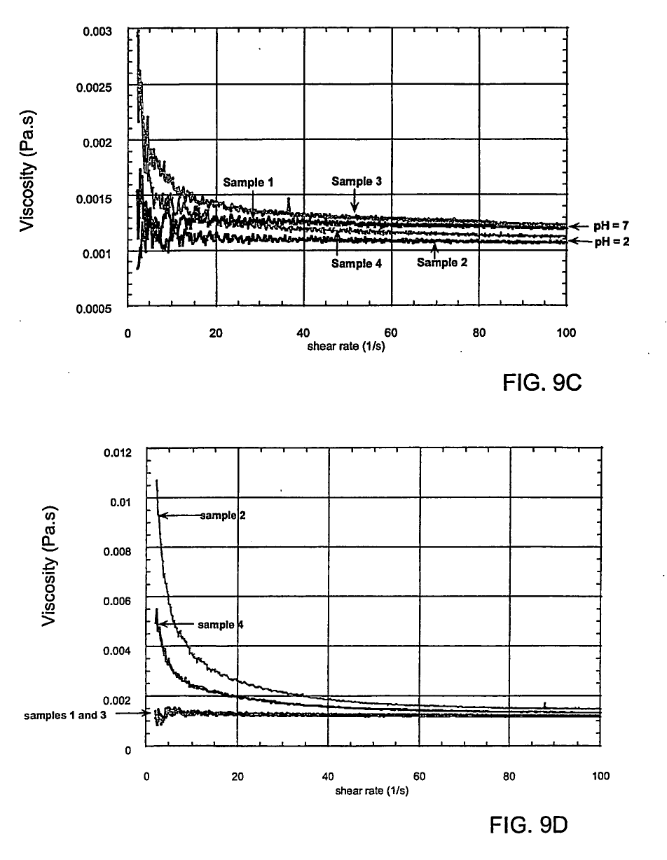

It however should be noted that the addition of NaCl reduces the viscosity of the DNSNH(CH2)₈NH₂ labeled HPAm (FIG. 9a). Samples 1 and 2 comprise 45.1 ppm non-labled HPAm, where sample 2 further comprises 5% NaCl. Samples 3 and 4 comprise 46.7 ppm labeled HPAm (17394 dansyl probes per chain), where sample 4 further comprises 5% NaCl. The salt apparently reduces repulsive forces between similar charges on the polymer chains, causing a shielding effect of the counterions present in the vicinity of the anionic sites of the labeled polymer. Such an effect reduces the size of the polymer coil, lowering the viscosity. Such a conformational change affects the microenvironment of the polymer and increases its quantum yield. The increase in fluorescence intensity in the presence of salt (NaCl) is essential to fluorescence imaging of polymer moieties in flow.

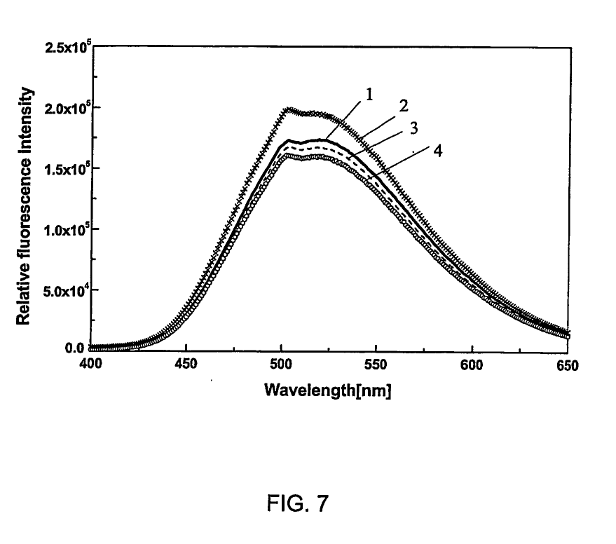

As mentioned above (Rivas, B. L., 1998), water-soluble polymers such as HFAm are used in the area of separation of mass in solution by utilizing the polymers as “polychelatogens”. HPAm comprises, both —COOH and CONH₂ functional groups, which are able to complex metal ions. Thus, in addition to the unique photoluminescence properties of the DNSNH(CH2)₈NH₂ labeled HPAm, the labeled polymer is also a complexing moiety for metal ions. The fluorescence probe of the labeled polymer (DNSNH(CH2)₈NH₂) is sensitive to metal induced fluorescence changes, most probably caused by conformational changes of the polymer. FIG. 7 shows the of fluorescence emission of HPAm labeled with 22.152 ppm DNSNH(CH2)₈NH₂ (19182 dansyl probes per chain) perturbed by 6.6×10⁻⁵ mol/l metal ions. Line 1 shows the relative fluorescence intensity of dansyl labeled HPAm. Lines 2, 3, and 4 show the relative fluorescent intensity of the complex where Cd(II), Cu(II) and Co(II) ions, respectively, were added to the complex. Fluorescence is thus a very sensitive measure for such complexing polymers. Hence measuring the fluorescence of the complex polymer is indicative of the presence of metal ions. Turning to the fluorescence shown in Fog. 7, while cadmium complexation cause an increase in fluorescence, cobalt and copper complexation quench the fluorescence. Thus the labeled polymer may serve as a metal collector or remover in aqueous solution and furthermore, it may serve as a sensitive indicator in environmental studies.

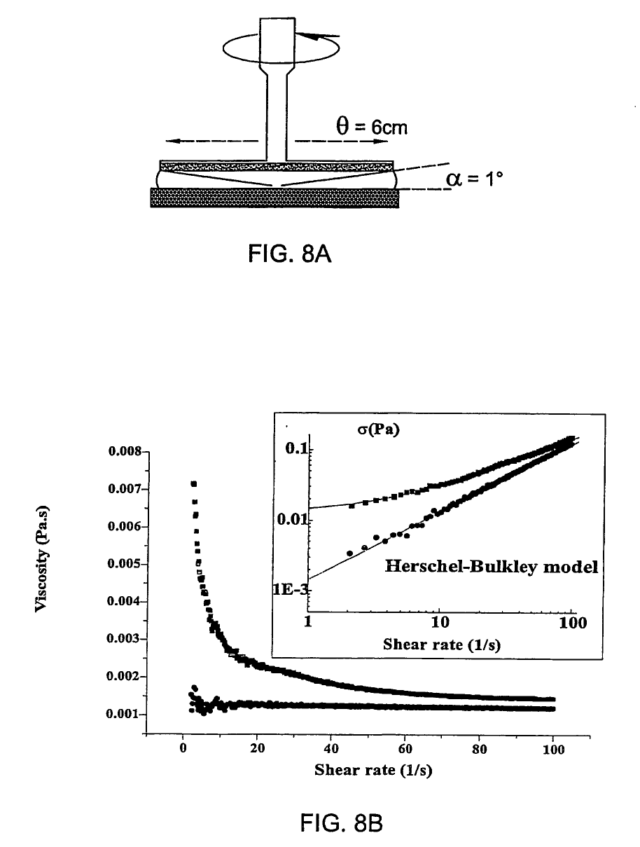

Conformational changes in the polymeric chain as a result of the binding of the fluorescent probe may be observed by comparing the Theological properties of the unlabeld polymer to those of the labeled polymer. Viscosity measurements of 45.1 ppm HPAm were compared to those of HPAm labeled by DNSNH(CH2)₈NH₂. Measurements were performed on a commercial instrument using cone-and-plate geometry (FIG. 8a). The rotation of the upper cone induces a circular shear-flow in the fluid that fills the space between the two parts of the instrument. For a small angle of the cone (α=1°, FIG. 8a), the geometry ensures a constant shear rate throughout the sample. The steady-shear viscosity η of the sample may be defined as the coefficient relating the shear stress σ to the shear rate dγ/dt in the steady shear flow: σ=η(dγ/dt₀) dγ/dt. The results of such measurements done for the free and fluorescent-probe bound polymer (45.1 ppm BPAm solution comprising 5% NaCl) are shown in FIG. 8b (● before labeling; ▪ after labeling). The two different curves clearly indicate that labeling the HPAm polymer indeed altered its viscosity properties. The unlabeled polymer exhibits a constant viscosity η_{UL}=1.22 mPa.s over a range of 2 to 100 s⁻¹ of shear rates. Following labeling, the labeled HPAm displays a viscosity that is shear-rate dependent. It strongly decreases as the shear rate increases after which it reaches a plateau at higher shear-rate values. The viscosity at the plateau is η_{L}=1.46 mPa.s, a value that is higher in about 20% than that of η_{UL}. One, however, would expect the opposite. One would assume that the labeled polymer be more compact than the unlabeled due to the hydrophobic interactions of the DNSNH(CH2)₈NH₂ groups, ultimately resulting in a lower viscosity. The explanation to this “discrepancy” can be found by plotting the shear stress vs. the shear rate which emphasizes the rheological properties of the two moieties. Following the labeling, a finite stress (yield stress) is needed to make the sample flow. Such a behavior is known as plastic behavior that is described by the Herschel-Bulkley model (insert in FIG. 8b) [The insert shows a plot of shear stress with respect to shear rate. Curves are fitted with the Herschel-Bulkley model: σ=σ_{y}+K(dγ/dt)ⁿ; ● before labeling σ_{y}(yield stress)=3.6×10⁻⁷ Pa, K=1.44×10⁻³ (Pa.s)ⁿ, n=0.9615; ▪ after labeling σ_{y}(yield stress)=1.19×10⁻² Pa, K=2.82×10⁻³ (Pa.s)ⁿ, n=0.8335]. Such a change may be attributed to the formation of a complex polymeric superstructure as a result of the strong hydrophobic interactions between the DNSNH(CH2)₈NH₂ present on the polymer chains. Such an effect would ultimately be reduced (weaker) as the number of DNSNH(CH2)₈NH₂ groups decreases per chain. Such an explanation is confirmed by the curve shown in FIG. 9b demonstrating changes in viscosity as a function of shear rate. In the figure, Sample 1 comprises 45.1 ppm HPAm in the presence of 5% NaCl. Sample 2 is comprises 45.1 ppm HPAm labeled with DNSNH(CH2)₈NH₂ (17394 dansyl probes per chain) further comprising 5%, NaCl. Samples 3 and 4, comprise 45.1 ppm HPAm labeled with DNSNH(CH2)₈NH₂ (mol ratio of COOH/dansyl group is 1:0.11) further comprising 5% NaCl, where in Sample 3 the result is after one day reaction, while Sample 4 comprises a solution obtained after two days of reaction. Another effect on the viscosity of the complex may be observed by varying the pH of the solution. Such a pH change is connected to alteration of the microenvironment of the fluorophore and leads to an observable, though small, decrease in the viscosity as shown in FIG. 9c. Sample 1 and 2 both comprise 45.1 ppm of HPAm further comprising 5% NaCl, however, Sample 1 is measured with pH=7, while Sample 2 is measured with pH=2. Sample 3 and 4 comprise 45.1 ppm BPAm labeled with DNSNH(CH2)₈NH₂ (mol ratio of of COOH/dansyl group is 1:0.11) further comprising 5% NaCl, where in Sample 3 the result is after one day reaction and the pH is 7, while Sample 4 comprises a solution obtained after two days of reaction and pH is 2. As described above, the protonation of the dimethylamino group of the dansyl molecule, is achieved at pH=2. The strong hydrophobic interactions between the dansyl probes are possibly compensated by the electrostatic repulsion between charged dansyl molecules.

The existence of macromolecular complexes may be confirmed by stirring the non-labeled and labeled solutions for a period of about three hours, assuming the complexes, as a result of the stirring, would be destroyed. The applied force did not change the viscosity of the non-labeled moieties (FIG. 9d) indicating that no chain breakage occurred. In the figure, Samples 1 and 3 both comprise 46.7 ppm HPAm in 5% NaCl (Sample 1 not degraded, while Sample 3 degraded). Samples 2 and 4 comprise 45.76 ppm of HPAm labeled with DNSNH(CH2)₈NH₂ (17394 dansyl probes per chain) in 5% NaCl (where Sample 2 is not degraded, while Sample 4 degraded). The labeled moieties, however, displays as a result of such stirring a rheological pattern closer to that of the non-labeled moiety. It may thus be concluded that such stirring destroys, at least partially, the association of macromolecular structure responsible for a high viscosity at low shear rates.

The chemical labeling of HPAm with DNSNH(CH2)₈NH₂ modifies the physical properties of the obtained labeled polymer (P[Am*]ₓ[AM]₈₅[AA₁₅₋ₓ). The conformation as well as the susceptibility under flow is altered indicating that labeling not only changes viscosity but more deeply affects the Theological properties of the sample. It should, however, be noted that the concentration of the labeled polymer, P[Am*]ₓ[Am]₈₅[AA]₁₅₋ₓ in a solution of the polymer, required for measuring single-molecule dynamics by fluorescence microscopy is very low, less than 2 ppm, compared to much higher concentrations required for viscosity measurements. At such low concentrations, the hydrophobic interactions between bound labels become negligible and the physical properties of the labeled polymer are rather close to those of the unlabeled polymer. Furthermore, reducing the number of fluorescent probes per chain may weaken the hydrophobic interactions. Indeed, attaching a fluorescence probe to a polyacrylamide having a low degree of hydrolysis proved the latter. It was found out (data not shown) that the fluorescencet probe did not effect the rheological properties of the labeled polymer. In addition, electrostatic interactions in strong acidic environment and salt concentrations may be used to partially balance the hydrophobic interactions. Vigorous stirring degrades the polymeric structure of the labeled polymer. Thus it may be concluded that the labeled polymer P[Am*]ₓ[Am]₈₅[AA]₁₅₋ₓ may be a sensitive tool for measuring polymer dynamics in complex flow.

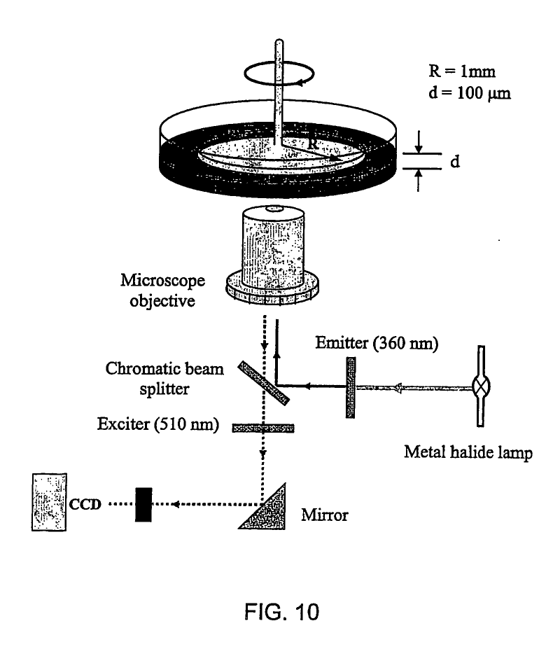

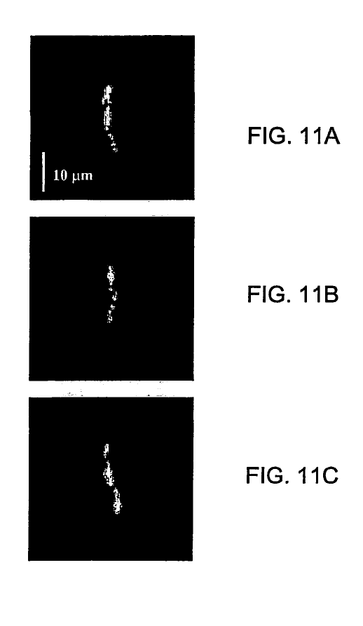

The labeled polymer P[Am*]ₓ[Am]₈₅[AA]₁₅₋ₓ of the present invention may further be observed and studied by fluorescence microscopy. Fluorescence microscopy may be used initially to verify the efficiency of labeling and later on may be used for studying polymer dynamics in complex flow. Visualization of a single polymer is a unique phenomenon in synthetic polymers. FIG. 10 shows a schematic representation of an apparatus for directly measuring and displaying fluorescence microscopy of the labeled P[Am*]ₓ[Am]₈₅[AA]₁₅₋ₓ. Generally, a fluorescence microscope is equipped with an intensified CCD camera. The obtained pictures may then be digitized by computer and recorded on a VCR The polymer sample is placed between two parallel horizontal disks. While at rest, the polymer chains are coiled. The rotation of the upper plate generates a circular shear-flow in the fluid. In cases where the rotation is done at a high speed, the velocity gradient developed within the fluid stretch the polymer chains. High speed is necessary in order to exert hydrodynamic force strong enough to overcome the entropic forces that tend to keep the polymer in its coiled state. The results of P[Am*]ₓ[Am]₈₅[AA]₁₅₋ₓ polymers stretched by circular shear flow are shown in FIG. 11. FIG. 11A shows the polymer-coiled chains at rest. Upon the generation of a circular shear-flow in the fluid, the polymer coils begin to stretch (FIG. 11B), where high speed circular shear-flow generates a further stretching of polymer coils. The molecular extension is about 15 μm. It is thus demonstrated that chemical labeling of a polymer with a fluorescent probe enables visualization and measurements of single-molecule dynamics of synthetic polymers.

Experimental

### Example 1

### Synthesis of N-(8-aminooctanyl)-5-dimethylamino-1-naphthalene-sulphonamide (DNSNH(CH2)₈NH₂)

Dansyl chloride (2.757 g, 10 mmol) was partially dissolved into 150 ml CHCl₃ forming a turbid yellow solution. The solution was dropped into a mixture of 1,8-diaminooctane (2.2885 gr, 20 mmol), triethylamine (1.4 ml, 10 mmol) and CHCl₃ (70 ml). Rate of addition was such that the reaction mixture maintained a light green fluorescent color (ca. 4 hours) and left overnight. The precipitate was isolated and purified by flash chromatography [1. Hexane:ethylacetate (3:2); 2. CHCl₃:CH₃OH:NH₃(25% aqueous) (5:1:0.1)] to yield a yellow oily product (1.108 g-29% yield). TLC[CHCl₃:CH₃OH:NH₃(25% aqueous) (5:1:0.1)]: R_{f}=0.3. Positive staining by ninhydrin.

NMR: δ (CDCl3, TMS): 1.17 (br, m, 8H, —SO₂NH(CH₂)7—), 1.39 (m, 4H, —SO₂NH(CH₂)₈NH₂—), 2.2-2.4 (br,2H, —CH₂NH₂), 2.67 (t, 2H, SO₂NHCH₂—), 2.96 (m, 8H, N(CH₃)₂, —CH₂NH₂), 7.17 (d, 1H; arom., H6), 7.56 (q, 2H, arom. H7, H3), 8.25 (q, 2H, arom. H2, H8), 8.55 (d, 1H, arom., H4).

### Example 2

### Synthesis of DNSNH(CH2)₈NH₂-caproyly

DNSNH(CH2)₈NH₂ (24.6 mg, 0.065 mmol) was dissolved in 0.5 ml DMSO and rotated slowly. A mixture of 74.5 mg (0.38 mmol) 1-[3-(dimethylamino)-propyl]-3-ethylcarbodiimide hydrochloride (EDC) and 6 μl caproic acid (0.05 mmol) in 5 ml of phosphate buffer (pH 5.6) was added, and the combined mixture was left to rotate for 5 hours in the dark. The water was removed under high vacuum, and a yellow, oily material was obtained which was purified by flash chromatography (hexane:ethylacetate=1:2.5) and final structure confirmed by NMR.

### Example 3

### Synthesis and Purification of P[Am*]ₓ[Am]₈₅[AA]₁₅₋ₓ

A series of compounds of P[Am*]ₓ[Am]₈₅[AA]₁₅₋ₓ each having a different number of dansyl probes were prepared. Various compounds are shown in Table 1. It should be noted that a mol ratio of the COOH/dansyl in the reaction mixture of about 1:1 or higher, resulted in a turbid solution.

TABLE 1

| | COOH/ | | | |
|---|---|---|---|---|
| | dansyl ratio | | | |
| Sample | (m) in reaction | Polymer conc. after | No. dansyl | Solution |
| No. | mixture | dialysis (ppm) | probes/chain | status |
| 1 | 1:0.095 | 61.4 | 777 | clear |
| 2 | 1:0.2 | 45.1 | 17394 | clear |
| 3 | 1:0.44 | 88.5 | 18881 | Clear |
| 4 | 1:0.66 | 66.458 | 19182 | clear |

A general procedure for their synthesis is the following.
Stock solution of 1000 ppm HPAm (PolyScience) is prepared by dissolving 1 g of polymer in 11 ml of water and 250 ppm NaN₃ (for preserving);
EDC (in 10 times excess with resect to the molar quantity of COOH group) is added to a solution of 20 ml HPAm (1000 ppm) containing 250 ppm NaN3, that is slowly rotated (0.5 rpm/min—slow rotation is required for preventing the chain degradation of HPAm) for 0.5 hr. DNSNH(CH2)₈NH₂ dissolved in DMSO (concentration varies from 2×10⁻⁴ to 3.58×10⁻³) is added to the polymers solution in aliquots of 3 ml. Each addition is followed b rotation of 20 min. At the end of the addition of the DNSNH(CH2)₈NH₂ the mixture is allowed to rotate in the dark for one week.

### Example 4

### Purification of P[Am*]ₓ[Am]₈₅[AA]₁₅₋ₓ

The fluorescent probe synthesized as explained in Example 3 was purified by dialysis against an aqueous solution (pH=4) to remove unreacted DNSNH(CH2)₈NH₂ and further against water. Size Exclusion Chromatography (SEC) was used to monitor the purity of the product. After dialysis the solution comprising the labeled polymer (2 ml) was loaded on Sephadex® 50 in 15 mm×1.5 mm column and eluted by water. Each fraction was characterized by its fluorescence (maximum emission 520 nm), and TLC (CH₃Cl/CH₃OH 9:1) confirming that no unreacted DNSNH(CH2)₈NH₂ is present after dialysis which removed both unreacted DNSNH(CH2)₈NH₂ and free HPAm. To prevent bacterial growth, NaN₃ (250 ppm) and 5% NaCl are added to the labeled polymer.

### Example 5

### Analysis of the P[Am*]ₓ[Am]₈₅[AA]₁₅₋ₓ Product

The actual concentration of the polymer P[Am]ₓ[Am]₈₅[AA]₁₅₋ₓ in the dansyl-labeled solution was determined by accurate weighing after lyophilization. 10 ml of the labeled polymer stock solution were dried by lyophilization for 4 days and the white residue was then accurately weighed. The concentration of polymer in the original solution was calculated and expressed in ppm values. The number of dansyl groups attached to the polymer chain was determined following a known 1 method (Huff et al. 1997). Standard solutions of DNSNH(CH₂)₈NH₂ and dansyl-labeled P[Am*]ₓ[Am]₈₅[AA]₁₅₋ₓ were prepared in pH 5.6 buffer. Standard curves giving concentration versus absorption at 320 nm for DNSNH(CH₂)₈NH₂ and at 340 nm for dansyl-labeled P[Am*]ₓ[Am]₈₅[AA]₁₅₋ₓ were plotted. The ratio of the slopes from the two curves was used to calculate the number of dansyl groups attached to the polymer. The technique may be used as long as the concentration of the dansyl-labeled polymer used for the standard curve is lower than 35 ppm. It should be mentioned that although the absorption band of the dansyl probe and HPAm overlap to a certain extent, the absorption of HPAmsolution at 340 nm remians negligible up tp a concentration of 35 ppm. Thus the absorption intensity observed and measured at 340 nm is assumed to originate only from the dansyl-labeled probe. The calculated results are those shown in Table 1.

1. A complex formed by the reaction of a compound of formula (I): 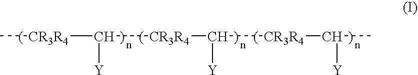
with a fluorescent compound of formula (II) 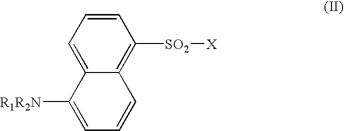
wherein R₁—R₄ may be the same or different and are selected from the group consisting of hydrogen, substituted or non-substituted C₁-C₁₂-alkyl, C₁-C₁₂-alkenyl, phenyl, and alkylphenyl;
each n, which may be the same or different, is from 1 to 120; and
X and Y are functional groups that may interact one with the other to form the desired chemical bond and are chosen independently from the group consisting of halogen, amino, carboxyl, carboxamide, C₁-C₁₂-halogen, C₁-C₁₂alkyl-NH₂, NH₂—C₁-C₁₂alkyl-NH₂, C₁-C₁₂-carboxyl, and C₁-C₈-hydroxy, where the Y groups may be the same or different.

2. A complex according to claim 1 wherein R₁—R₄ may be the same or different and are selected from the group consisting of hydrogen, substituted or non-substituted C₁-C₁₂-alkyl, X and Y are selected from amino, carboxyl, carboxamide, NH₂—C₁-C₁₂alkyl-NH₂ and C₁-C₁₂-carboxyl.

3. A complex according to claim 1 wherein R₁ and R₂ are C₁-C₄-alkyl, R₃ and R₄ are hydrogen, X is NH₂—C₁-C₁₂alkyl-NH₂ or C₁-C₁₂alkyl-NH₂; and Y is carboxyl or carboxamide.

4. A complex according to claim 1 of formula (III):

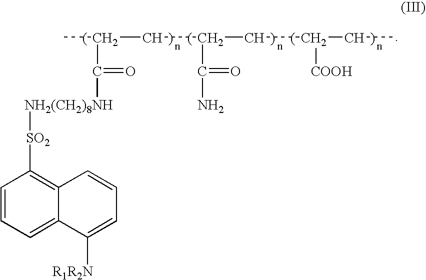

5. A method for measuring dynamics of single-molecule in a polymeric solution comprising the steps of
(a) providing a complex formed by reacting a compound of formula (I) 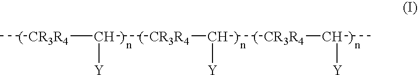
with a compound of formula (II) 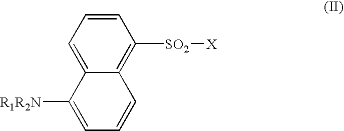
wherein R₁—R₄ may be the same or different and are selected from the group consisting of hydrogen, substituted or non-substituted C₁-C₁₂-alkyl, C₁-C₁₂-alkenyl, phenyl, and alkylphenyl; each n, which may be the same or different, is from 1 to 120; and
X and Y are functional groups that may interact one with the other to form the desired chemical bond and are chosen independently from the group consisting of halogen, amino, carboxyl, carboxamide, C₁-C₁₂-halogen, C₁-C₁₂alkyl-NH₂, NH₂—C₁-C₁₂alkyl-NH₂, C₁-C₁₂-carboxyl, and C₁-C₈-hydroxy, where the Y groups may be the same or different; and
(b) measuring the flourescence of said chemical complex or visualizing said chemical complex directly.

6. The method of claim 5, wherein the chemical complex is a compound of formula (III):

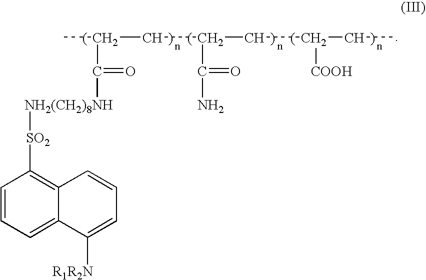

7. The method of claim 5, wherein visualization of the complex of formula (III) under flow is carried by with a fluorescent microscope.

8.-14. (canceled)

15. A process for preparing a complex of formula (III): 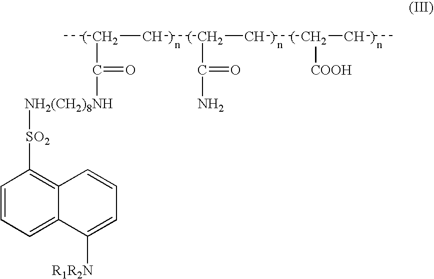
comprising the steps of reacting dansylchloride with 1,8-diaminooctane 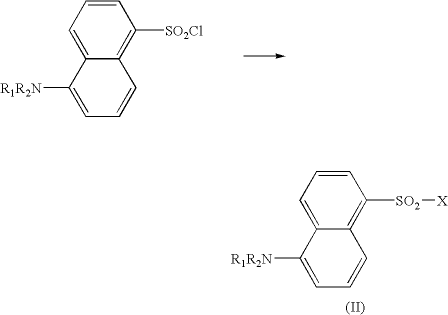
to form a compound of formula (II), which is then reacted with a compound of formula (I) to form a compound of formula (III): 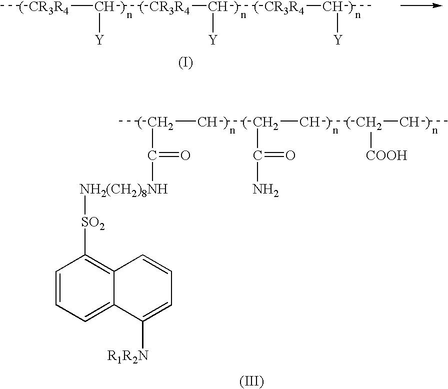
wherein R₁13 R₄ may be the same or different and are selected from the group consisting of hydrogen, substituted or non-substituted C₁-C₁₂-alkyl, C₁-C₁₂-alkenyl, phenyl, and alkylphenyl; each n, which may be the same or different, is from 1 to 120; and
X and Y are functional groups that may interact one with the other to form the desired chemical bond and are chosen independently from the group consisting of halogen, amino, carboxyl, carboxamide, C₁-C₁₂-halogen, C₁-C₁₂alkyl-NH₂, NH₂—C₁-C₁₂alkyl-NH₂, C₁-C₁₂-carboxyl, and C₁-C₈-hydroxy, where the Y groups may be the same or different.
